(19) United States
(12) Patent Application Publication
(10) Pub. No.: US 2003/0000351 A1
(43) Pub. Date: Jan. 2, 2003

(54) Interference fit screw driver

(75) Inventor: David T. Hawkes, Draper, UT (US)

Correspondence Address: KARL R CANNON, PO BOX 1909, SANDY, UT, 84091, US

(73) Assignee: Ortho Development Corporation

(21) Appl. No.: 09/894,330

(22) Filed: Jun. 28, 2001

(51) Int. Cl. B25B 23/08

(52) U.S. Cl. 81/451

(57) ABSTRACT

An interference fit screw driver has a polygonal driving surface to impart torque to a corresponding surface in a screw. The end of the polygonal driving surface has a frusto-conical shaped gripping member which fits into an aperture in the screw to create a friction fit between the screw and screw driver. This allows the screw to be attached to the screw driver to facilitate installation of the screw. The friction fit is tight enough to hold the screw to the driver, yet allows the driver to be easily disengaged from the screw by pulling the driver away from the screw once the screw is lodged in place. The interference fit screw driver is particularly useful in turning bone screws into the spine of a patient during orthopedic surgery.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. The Field of the Invention

The present invention relates generally driving tools, and more particularly, but not necessarily entirely, to screw drivers capable being attached to screws by an interference fit for use in orthopedic surgery, to turn bone screws into the spine of a patient.

2. Description of Related Art

A typical screw driver known in the art has a driving surface or bit which mates with a complementary recess on a screw to allow the screw driver to impart torque to the screw. An area of concern related to screw drivers has been retaining the screw on the bit of the driver while positioning the screw. This aspect of screw drivers is particularly important in the medical profession, for example, as bone screws are inserted into the spine of a patient during orthopedic surgery.

Screw drivers known in the prior art have used various techniques to attach the screws to the bits. For example, U.S. Pat. No. 4,970,922 (granted Nov. 20, 1990 to Krivec) discloses a rotatable driving tool having a plurality of substantially circularly helical driving portions with small helix angles. The driving portions mate with lobes of the fastener recess but are slightly inclined with respect to the lobes. This provides a wedge fit to retain the fastener with the tool. However, the inclined driving portions allow the driver to efficiently apply torque only in one direction. If torque is applied to the fastener in the opposite direction, the inclined driving portions force the driver out of engagement with the lobes of the fastener. Thus, a reverse driver may be required to remove the screw.

Another approach has been to use a tapered bit on the driving tool which is adapted to wedge into the recess of the screw. For example, U.S. Pat. No. 4,269,246 (granted May 26, 1981 to Larson et al.) discloses a driver bit with multiple lobes. The lobes are tapered axially, converging toward the tip end of the driver. The driver bit enters a socket of the fastener to a predetermined depth before wedging the fastener to the driver. A disadvantage of this arrangement is that the bit engages the fastener only at the outer end of the socket. This results in inefficient transfer of the torque from the driving member to the fastener. Also the concentration of force at one contact location tends to wear and deform the socket in the contact region. Furthermore, close tolerances are necessary in order to provide the proper wedge fit in a consistent manner.

U.S. Pat. No. 5,277,531 (granted Jan. 11, 1994 to Krivec) discloses another technique for attaching a fastener to a tool. This patent discloses a polygonal shaped tool fitting a socket recess formed in a fastener. The recess has planar drive surfaces alternating with sloping retaining surfaces. The polygonal tool is wedged in contact with the sloping retaining surfaces to retain the fastener on the tool. This configuration also reduces the contact area between the tool and the fastener. Furthermore, if significant torque is applied to the fastener, the retaining surfaces may become tightly wedged to the tool making it difficult to release the fastener.

An additional type of retention technique is the use of a magnetized bit on the driving tool. However, this type of retention is only useful in screws formed of magnetic material.

The prior art is thus characterized by several disadvantages that are addressed by the present invention. The present invention minimizes, and in some aspects eliminates, the above-mentioned failures, and other problems, by utilizing the methods and structural features described herein.

In view of the foregoing state of the art, it would be an advancement in the art to provide an interference fit screw driver which is simple in design and manufacture which is attached to a screw by a friction fit to facilitate positioning the screw. It would be a further advancement in the art to provide such a screw driver which is capable of applying torque in two directions and which engages the screw over a large surface area such that wear and deformation of the screw and screw driver are reduced, and which can be released from the screw even after a large torque has been applied to the screw by the screw driver. It would be an additional advancement in the art to provide a screw driver which is capable of retaining contact with screws made of nonmagnetic materials.

### BRIEF SUMMARY AND OBJECTS OF THE INVENTION

It is therefore an object of the present invention to provide an interference fit screw driver which is simple in design and manufacture.

It is an additional object of the present invention to provide a screw driver which is capable of driving a screw by an interference fit.

It is a further object of the present invention to provide an interference fit screw driver which is attached to a screw by a friction fit to facilitate positioning the screw.

It is another object of the present invention to provide such a driver which is capable of applying torque in two directions.

It is a further object of the present invention, in accordance with one aspect thereof, to provide a screw driver which engages the screw over a large surface area such that wear and deformation of the screw and screw driver are reduced.

It is an additional object of the invention, in accordance with one aspect thereof, to provide an interference fit screw driver which can be released from the screw even after a large torque has been applied to the screw by the screw driver.

It is another object of the present invention to provide a screw driver which is capable of retaining contact with screws made of nonmagnetic materials.

The above objects and others not specifically recited are realized in a specific illustrative embodiment of an interference fit screw driver. The device preferably includes a body having a proximal end and a distal end. The distal end of the body preferably has a polygonal driving means for driving the driven member. The device also includes a gripping means for gripping the driven member to attach the driven member to the tool. The gripping means preferably has a substantially frusto-conical shape and may be disposed on the end of the driving means to fit into an aperture in the driven member. The gripping means wedges against an edge of the aperture to attach the driven member to the tool with a friction fit.

Additional objects and advantages of the invention will be set forth in the description which follows, and in part will be apparent from the description, or may be learned by the practice of the invention without undue experimentation. The objects and advantages of the invention may be realized and obtained by means of the instruments and combinations particularly pointed out in the appended claims.

### BRIEF DESCRIPTION OF THE DRAWINGS

The above and other objects, features and advantages of the invention will become apparent from a consideration of the subsequent detailed description presented in connection with the accompanying drawings in which:

FIG. 1 is a side view of a screw driver and screw made in accordance with the principles of the present invention, the upper portion of the screw being a cross-sectional view;

FIG. 2 is an end view of the screw driver of FIG. 1.

FIG. 3 is a break-away cross-sectional view of an alternative embodiment of the screw driver and screw of FIG. 1.

FIG. 4 is an end view of the alternative embodiment of the screw driver of FIG. 3.

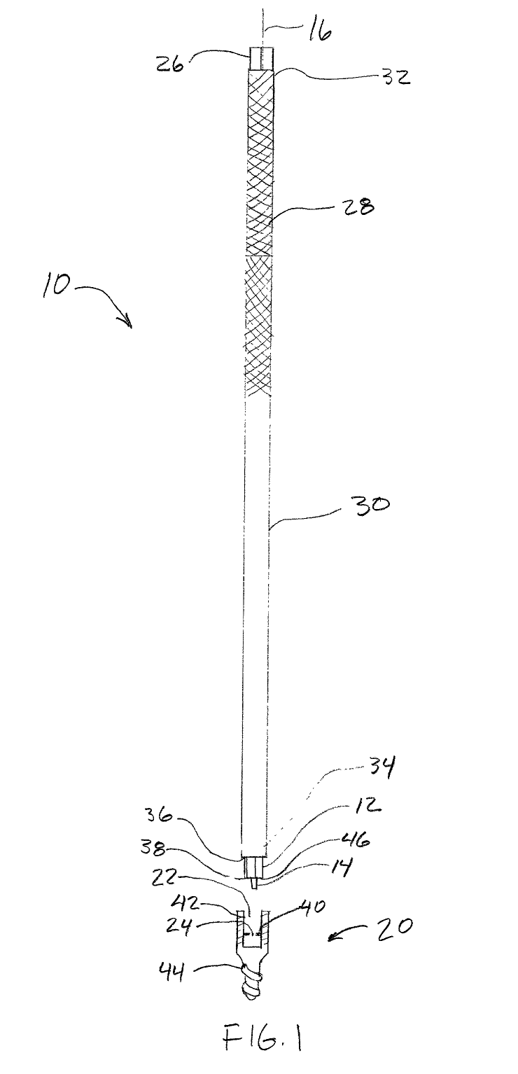

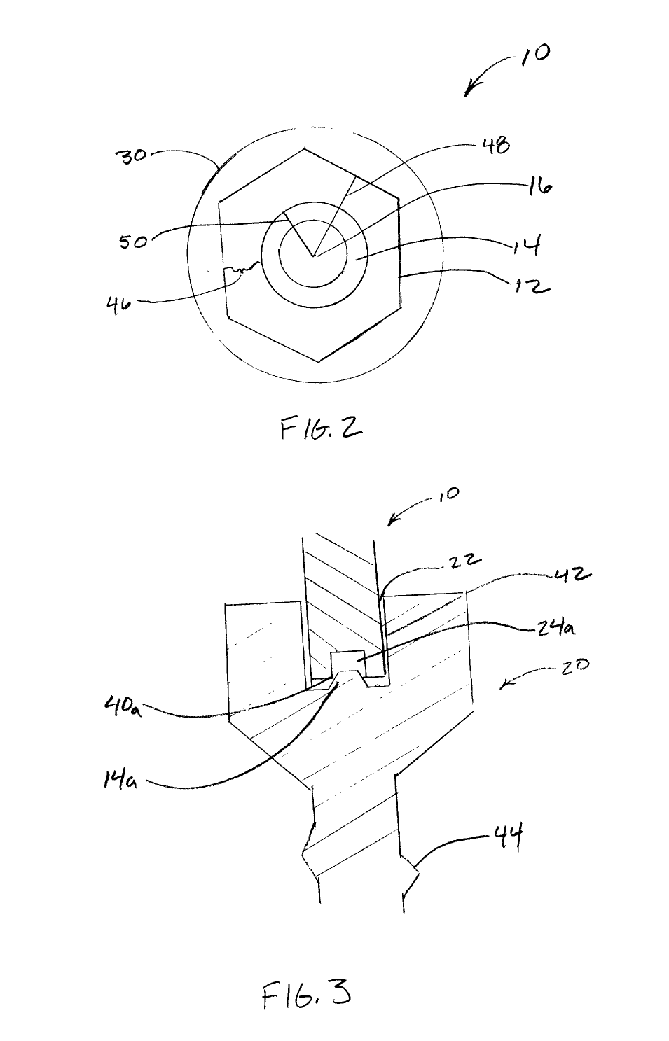

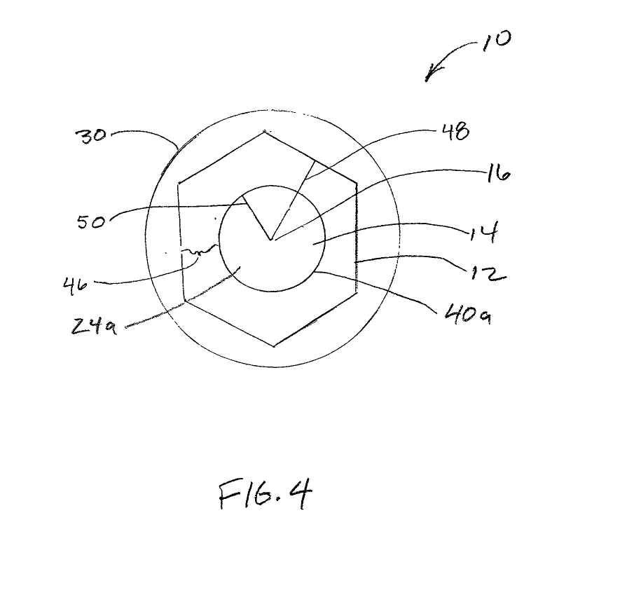

### DETAILED DESCRIPTION OF THE PREFERRED EMBODIMENTS

For the purposes of promoting an understanding of the principles in accordance with the invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

Referring now to FIG. 1, a side view is shown of an exemplary embodiment of a screw driver 10, also referred to herein more generally as a tool, and a screw 20, also referred to herein more generally as a driven member, in accordance with the principles of the present invention. The screw driver 10 is preferably substantially cylindrical shaped having a longitudinal axis 16, and includes a body 30 having a proximal end 32 and a distal end 34. The body 30 preferably includes a fitting 26 disposed on the proximal end 32, to allow a user to attach an implement, such as a wrench, to facilitate applying torque if necessary. The fitting 26 may be a polygonal surface or socket for example. However, as those skilled in the art will appreciate, various different configurations may be used as fittings within the scope of the present invention. The body 30 also preferably includes a handle 28 disposed on the proximal end 32 to facilitate gripping the body 30 so that torque may be applied more easily without slipping. The handle 28 may be formed of a series of grooves or knurls in the body 30 to create a frictional surface. Other varieties of handles known in the art may also be used within the scope of the present invention.

A driving means 12 is preferably disposed on the distal end 34 of the body 30. The driving means 12 has a first end 36, a second end 38, and preferably has a constant cross-sectional configuration throughout the length of the driving means 12. The constant cross-section allows efficient transfer of torque from the screw driver 10 to the screw 20 without the tendency to separate as is common with tapered driving surfaces. Also, the constant cross-sectional configuration allows the drive means 12 to impart torque efficiently when rotated in both clockwise and counter-clockwise directions. This feature is an improvement over driving surfaces with curved or angled driving surfaces which work transfer torque efficiently only in one direction.

The driving means 12 is preferably polygonal in shape. For example, the polygonal shape of the driving means 12 may be a hexagonal shape as shown most clearly in FIG. 2. However, as those skilled in the art will appreciate, driving surfaces of various shapes, such as star shapes, cross shapes, blade shapes, or fluted configurations, may be used within the scope of the present invention.

A gripping means 14 is preferably disposed on the second end 38 of the driving means 12 for gripping the screw 20 to removably attach the screw 20 to the screw driver 10. The gripping means 14 is preferably substantially frusto-conical in shape, however other configurations are possible within the scope of the present invention. The gripping means 14 is preferably located along the axis 16 such that a break 46 is disposed radially from the longitudinal axis 16 between the driving means 12 and the gripping means 14. The separation of the gripping means 14 from the driving means 12 allows the gripping means 14 to function independently from the driving means and vice versa. The function of the gripping means 14 is described more fully below.

The driving means 12 preferably has a radial dimension 48 from the longitudinal axis 16 of the tool which is larger than a radial dimension 50 of the gripping means 14. The difference in radial dimension forms the radial break 46 to separate the drive means 12 from the gripping means 14, and to provide a larger surface area to the driving means 12 for applying torque than for gripping the screw. Preferably the radial dimension 48 of the driving means 12 is sized in a range of between approximately two to four times the radial dimension 50 of the gripping means 14 from the longitudinal axis 16.

The screw 20 preferably includes a first aperture 24 and a second aperture 22. The first aperture 24 is preferably aligned coaxially with the second aperture 22 and smaller than the second aperture 22, such that the second aperture 22 circumscribes the first aperture. The first aperture 22 is defined by a circumferential edge 40 which is engaged by the gripping means 14 to attach the screw 20 to the screw driver 10. The first aperture 22 and edge 40 are preferably circular in shape, however, various shapes may be used within the scope of the present invention. The second aperture 22 is preferably defined by a socket 42 which is engaged by the driving means 12 of the screw driver 10 to form an interference fit. The socket 42 preferably has a shape which corresponds to the shape of the driving means 12, such as hexagonal for example. However, it will be appreciated that the socket 42 may have various corresponding shapes of polygons, stars, crosses, blades, or fluted configurations for example, within the scope of the invention. The screw 20 also preferably has threads 44 of any variety known in the art. However, the principles of the present invention may be applied to any such driven member which may employ other engaging means such as flanges or pins for example, besides threads.

In use, the screw 20 is attached to the screw driver 10 by inserting the gripping means 14 into the first aperture 24 to the point where the edge 40 engages the gripping means 14 to wedge the gripping means 14 against the edge 40 with a friction fit. Preferably, the area of contact between the gripping means 14 and the edge 40 is large enough to supply sufficient force to attach the screw 20 to the screw driver 10, yet small enough such that the screw 20 may be released when desired without undue effort. As the gripping means 14 enters the first aperture 24, the driving means 12 is aligned against the socket 42. The surface area of the contact between the driving means 12 and the socket 42 is large as compared to the contact between the gripping means 14 and the edge 40. This relationship allows efficient transfer of torque from the screw driver 10 to the screw 20 without imposing concentrated loads on a single point. Furthermore, since the contact between the driving means 12 and the socket 42 is separate from the contact between the gripping means 14 and the edge 40, the screw 10 can be easily released from the screw driver 10, regardless of how much torque is applied. In other words, a high torque placed on the socket 42 by the driving means 12, has no effect on the frictional connection between the gripping means 14 and the edge 40. Once it is desired to release the screw 20 from the screw driver 10, the screw driver 10 is simply pulled from the screw 20 with a force sufficient to overcome the frictional fit between the gripping means 14 and the edge 40.

Manufacturing of the present invention is facilitated since the gripping means 14 and edge 40 need not be constructed to exact dimensions to allow proper attachment of the screw 20 to the screw driver 10. The tapered surface of the gripping means 14 allows a friction fit against the edge 40 at various longitudinal locations along the gripping means 14 depending upon the size of the first aperture 24. Furthermore, since the screw 20 is attached to the screw driver 10 by a friction fit, the use of magnetic materials is not necessary. The screw driver 10 and screw 20 may be constructed of various materials know to those skilled in the art.

Reference will now to made to FIG. 3 to describe a second embodiment of the present invention. As previously discussed, the presently preferred embodiments of the invention illustrated herein are merely exemplary of the possible embodiments of the invention, including that illustrated in FIG. 3.

It will be appreciated that the second embodiment of the invention illustrated in FIG. 3 contains many of the same structures represented in FIGS. 1-2 and only the new or different structures will be explained to most succinctly explain the additional advantages which come with the embodiments of the invention illustrated in FIG. 3. The second embodiment of the invention includes a tapered member 14a disposed on the screw 20, and a gripping means including a first aperture 24a and edge 40a disposed on the screw driver 10. The function of the second embodiment of the invention is similar to that of the first embodiment. An advantage of the second embodiment is that the tapered member 14a is protected within the socket 42. Therefore, damage to the tapered member 14a is less likely so that a proper fit between the screw 20 and the screw driver 10 is allowed.

In accordance with the features and combinations described above, a preferred method of driving a driven member 20 with a tool 10 includes the steps of:

A) inserting a gripping means 14 into a first aperture 24 to attach the driven member 20 to the tool 10; and

B) inserting a driving means 12 into a second aperture 22 to transfer a driving force from the tool 10 to the driven member 20.

In view of the foregoing, it will be appreciated that the present invention provides an interference fit screw driver which is simple in design and manufacture which is attached to a screw by a friction fit to facilitate positioning the screw. The present invention also provides such a screw driver which is capable of applying torque in two directions and which engages the screw over a large surface area such that wear and deformation of the screw and screw driver are reduced. The present invention also provides a screw driver which can be released from the screw even after a large torque has been applied to the screw by the screw driver. The present invention also provides a screw driver which is capable of retaining contact with screws made of nonmagnetic materials.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A tool for driving a driven member, said tool comprising:
a body having a proximal end and a distal end;
a driving means disposed on the distal end of the body for contactibly driving said driven member; and
a gripping means disposed on a distal end of the driving means for gripping said driven member.

2. The tool of claim 1 wherein said driving means has a polygonal cross section.

3. The tool of claim 2 wherein said driving means has a hexagonal cross section.

4. The tool of claim 1 wherein said driving means has a constant cross sectional configuration.

5. The tool of claim 1 wherein a fitting is disposed on said proximal end of said body to facilitate imparting torque to the tool.

6. The tool of claim 1 wherein a handle is disposed on the proximal end of the body to facilitate imparting torque to the tool.

7. The tool of claim 1 wherein said body has a substantially cylindrical shaped configuration.

8. The tool of claim 1 wherein said gripping means has a smaller surface area than said driving means.

9. The tool of claim 1 wherein said gripping means has a tapered configuration.

10. The tool of claim 10 wherein said gripping means comprises a substantial frusto-conical shape.

11. The tool of claim 1 wherein said driving means has a radial dimension from a longitudinal axis of said tool which is sized in a range of between approximately two to four times a radial dimension of said gripping means from said longitudinal axis.

12. The tool of claim 1 wherein said gripping means comprises a circumferential edge defining an aperture therewithin.

13. The tool of claim 12 wherein said aperture has a circular shape.

14. The tool of claim 1 wherein said body has a radial dimension which is greater than a radial dimension of said driving means, and wherein the radial dimension of said driving means is greater than a radial dimension of said gripping means.

15. A tool for driving a driven member, said tool comprising:
a body having a proximal end and a distal end;
a driving means for contacting said driven member; and
a gripping means for gripping said driven member to attach said driven member to said tool;
wherein said tool is configured such that said driving means contacts said driven member at a location spatially separated from said gripping means.

16. The tool of claim 15 wherein said driving means has a polygonal cross section.

17. The tool of claim 16 wherein said driving means has a hexagonal cross section.

18. The tool of claim 15 wherein said driving means has a constant cross sectional area along a longitudinal axis of said driving means.

19. The tool of claim 15 wherein a fitting is disposed on said proximal end of said body to facilitate imparting torque to the tool.

20. The tool of claim 15 wherein a handle is disposed on the proximal end of the body to facilitate imparting torque to the tool.

21. The tool of claim 15 wherein said body has a substantially cylindrical shaped configuration.

22. The tool of claim 15 wherein said gripping means has a smaller surface area than said driving means.

23. The tool of claim 15 wherein said gripping means has a tapered configuration.

24. The tool of claim 15 wherein said gripping means comprises a substantial frusto-conical shape.

25. The tool of claim 15 wherein said driving means has a radial dimension from a longitudinal axis of said tool which is sized in a range of between approximately two to four times a radial dimension of said gripping means from said longitudinal axis.

26. The tool of claim 15 wherein said driving means has a first end and a second end, said first end of said driving means being disposed on said distal end of said body and said gripping means being disposed on said second end of said driving means.

27. The tool of claim 26 wherein said gripping means comprises a circumferential edge defining an aperture therewithin.

28. The tool of claim 27 wherein said aperture has a circular shape.

29. A tool for driving a driven member, said tool comprising:
a body having a proximal end and a distal end, said distal end of said body having a driving means for driving said driven member; and
a gripping means for gripping said driven member to attach said driven member to said tool, said gripping means having a substantial frusto-conical shape.

30. The tool of claim 29 wherein said driving means has a polygonal cross section.

31. The tool of claim 29 wherein said driving means has a hexagonal cross section.

32. The tool of claim 29 wherein said driving means has a constant cross sectional area along a longitudinal axis of said driving means.

33. The tool of claim 29 wherein a fitting is disposed on said proximal end of said body to facilitate imparting torque to the tool.

34. The tool of claim 29 wherein a handle is disposed on the proximal end of the body to facilitate imparting torque to the tool.

35. The tool of claim 29 wherein said body has a substantially cylindrical shaped configuration.

36. The tool of claim 29 wherein said gripping means has a smaller surface area than said driving means.

37. The tool of claim 29 wherein said driving means has a radial dimension from a longitudinal axis of said tool which is sized in a range of between approximately two to four times a radial dimension of said gripping means from said longitudinal axis.

38. The tool of claim 29 wherein said driving means has a first end and a second end, said first end of said driving means being disposed on said distal end of said body and said gripping means being disposed on said second end of said driving means.

39. A tool for driving a driven member, said tool comprising:
a body having a proximal end and a distal end;
a driving means for contacting said driven member disposed on said distal end of said body, said driving means having a longitudinal axis and a constant cross-sectional area along a majority length of the longitudinal axis; and
a gripping means for gripping said driven member to attach said driven member to said tool, said gripping means having a tapered exterior surface.

40. The tool of claim 39 wherein said driving means has a polygonal cross section.

41. The tool of claim 40 wherein said driving means has a hexagonal cross section.

42. The tool of claim 39 wherein a fitting is disposed on said proximal end of said body to facilitate imparting torque to the tool.

43. The tool of claim 39 wherein a handle is disposed on the proximal end of the body to facilitate imparting torque to the tool.

44. The tool of claim 39 wherein said body has a substantially cylindrical shaped configuration.

45. The tool of claim 39 wherein said gripping means has a smaller surface area than said driving means.

46. The tool of claim 39 wherein said gripping means comprises a substantial frusto-conical shape.

47. The tool of claim 39 wherein said driving means has a radial dimension from said longitudinal axis which is sized in a range of between approximately two to four times a radial dimension of said gripping means from said longitudinal axis.

48. The tool of claim 39 wherein said driving means has a first end and a second end, said first end of said driving means being disposed on said distal end of said body and said gripping means being disposed on said second end of said driving means.

49. The tool of claim 39 wherein said driving means has a constant cross-sectional area along the entire length thereof.

50. A tool for driving a driven member, said tool comprising:
a body having a longitudinal axis;
a driving means disposed on said body for driving said driven member; and
a gripping means for gripping said driven member, to attach said driven member to said tool;
wherein the gripping means has a radial dimension which is less than a radial dimension of said driving means.

51. The tool of claim 50 wherein said driving means has a polygonal cross section.

52. The tool of claim 51 wherein said driving means has a hexagonal cross section.

53. The tool of claim 50 wherein said driving means has a constant cross sectional area along a longitudinal axis of said driving means.

54. The tool of claim 50 wherein a fitting is disposed on a proximal end of said body to facilitate imparting torque to the tool.

55. The tool of claim 50 wherein a handle is disposed on a proximal end of the body to facilitate imparting torque to the tool.

56. The tool of claim 50 wherein said body has a substantially cylindrical shaped configuration.

57. The tool of claim 50 wherein said gripping means has a smaller surface area than said driving means.

58. The tool of claim 50 wherein said gripping means has a tapered configuration.

59. The tool of claim 58 wherein said gripping means comprises a substantial frusto-conical shape.

60. The tool of claim 50 wherein said driving means has a radial dimension from said longitudinal axis which is sized in a range of between approximately two to four times a radial dimension of said gripping means from said longitudinal axis.

61. The tool of claim 50 wherein said gripping means comprises a circumferential edge defining an aperture therewithin.

62. The tool of claim 61 wherein said aperture has a circular shape.

63. The tool of claim 50 wherein said driving means has a first end and a second end, said first end of said driving means being disposed on a distal end of said body and said gripping means being disposed on said second end of said driving means.

64. The tool of claim 50 wherein a break is disposed radially from said longitudinal axis between said driving means and said gripping means.

65. A tool for driving a driven member, said tool comprising:
a body having a proximal end and a distal end;
a driving means for contacting said driven member; and
a gripping means for gripping said driven member to attach said driven member to said tool;
wherein said gripping means comprises a circumferential edge defining an aperture therewithin.

66. The tool of claim 65 wherein said driving means has a polygonal cross section.

67. The tool of claim 66 wherein said driving means has a hexagonal cross section.

68. The tool of claim 65 wherein said driving means has a constant cross sectional area along a longitudinal axis of said driving means.

69. The tool of claim 65 wherein a fitting is disposed on said proximal end of said body to facilitate imparting torque to the tool.

70. The tool of claim 65 wherein a handle is disposed on the proximal end of the body to facilitate imparting torque to the tool.

71. The tool of claim 65 wherein said body has a substantially cylindrical shaped configuration.

72. The tool of claim 65 wherein said aperture has a circular shape.

73. The tool of claim 65 wherein said driving means has a first end and a second end, said first end of said driving means being disposed on said distal end of said body and said gripping means being disposed on said second end of said driving means.

74. A combination tool and driven member comprising:
a first aperture formed within one of said tool and said driven member;
a tapered portion disposed on the other of said tool and said driven member;
a second aperture formed within said driven member; and
a driving means disposed on said tool;
wherein said tapered portion resides within said first aperture to thereby attach said driven member to said tool when said driving means resides within said second aperture to thereby impart a driving force to said driven member.

75. The combination tool and driven member of claim 74 wherein said first aperture is disposed on said driven member and said tapered portion is disposed on said tool.

76. The combination tool and driven member of claim 74 wherein said first aperture is disposed on said tool and said tapered portion is disposed on said driven member.

77. The combination tool and driven member of claim 74 wherein said driving means has a polygonal cross section.

78. The combination tool and driven member of claim 77 wherein said driving means has a hexagonal cross section.

79. The combination tool and driven member of claim 78 wherein said driving means has a constant cross sectional area along a longitudinal axis of said driving means.

80. The combination tool and driven member of claim 74 wherein said tool comprises a body having a proximal end, and a fitting disposed on said proximal end of said body to facilitate imparting torque to the tool.

81. The combination tool and driven member of claim 74 wherein said tool comprises a body having a proximal end, and a handle disposed on said proximal end of said body to facilitate imparting torque to the tool.

82. The combination tool and driven member of claim 74 wherein said tapered portion has a smaller surface area than said driving means.

83. The combination tool and driven member of claim 74 wherein said tapered portion comprises a substantial frusto-conical shape.

84. The combination tool and driven member of claim 74 wherein said driving means has a radial dimension from a longitudinal axis of said tool which is sized in a range of between approximately two to four times a radial dimension of said tapered portion from said longitudinal axis.

85. The combination tool and driven member of claim 74 wherein said first aperture is defined by a circumferential edge.

86. The combination tool and driven member of claim 85 wherein said aperture has a circular shape.

87. The combination tool and driven member of claim 74 wherein said second aperture is defined by a socket having a shape which corresponds to a shape of the driving means.

88. The combination tool and driven member of claim 85 wherein said circumferential edge has a diameter that is less than twenty percent of a length of the second aperture.

89. The combination tool and driven member of claim 88 wherein said diameter of said circumferential edge is less than three millimeters.

90. A method of driving a driven member with a tool, said method comprising the steps of:
A) inserting a tapered portion into a first aperture to attach the driven member to the tool; and
B) inserting a driving means into a second aperture to permit a driving force to be transferred from the tool to the driven member.

91. The method of claim 90 wherein the first aperture is disposed on the tool.

92. The method of claim 90 wherein the first aperture is disposed on the driven member.

93. The method of claim 90 further comprising attaching the tapered portion to the driven member with a friction fit.

94. The method of claim 90 further comprising transferring the driving force from the driving means to the driven member with an interference fit.

95. The method of claim 90 further comprising rotating the tool to drive the driven member.

96. The method of claim 93 further comprising removing the driven member from the tool by pulling on the tool with a force to overcome the friction fit.

97. The method of claim 90 wherein said first aperture is defined by a circumferential edge.

98. The method of claim 90 wherein step (A) further comprises inserting said tapered portion into an aperture defined by an annular ledge.

99. A combination tool and driven member, said combination comprising:
a body comprising a substantially cylindrical shape having a proximal end and a distal end, said body further comprising a fitting disposed on said proximal end of said body to facilitate imparting torque to said tool by an instrument, said body further comprising a handle disposed on said proximal end of said body to facilitate frictional engagement of the tool;
a driving means for contacting said driven member, said driving means having a first end and a second end, said first end of said driving means being disposed on said distal end of said body, said driving means further having a longitudinal axis and a constant cross-sectional configuration along the longitudinal axis, said constant cross-sectional configuration being hexagonal in shape;
a gripping means for gripping said driven member to attach said driven member to said tool, said gripping means being disposed on said second end of said driving means, said gripping means having a substantial frusto-conical shape;
wherein said driving means is separated from said gripping means such that a spatial break is disposed radially from said longitudinal axis between said driving means and said gripping means;
wherein said driving means has a radial dimension from said longitudinal axis which is sized in a range of between approximately two to four times a radial dimension of said gripping means, and wherein said radial dimension of said driving means is less than a radial dimension of said body;
said driven member comprises a first aperture defined by a circumferential edge, and a second aperture defined by a hexagonal socket corresponding in size to the hexagonal shape of the driving means, said first aperture being smaller than said second aperture such that said first aperture is coaxial with, and circumscribed by, said second aperture;
wherein when said gripping means is inserted into said first aperture to a point where said conical shape engages said circumferential edge, a friction fit is thereby created between said gripping means and said circumferential edge to attach the driven member to the tool;
wherein the tool and driven member are configured such that as the gripping means is inserted into said first aperture, said driving means is inserted into said second aperture to engage said hexagonal socket in an interference fit, such that a rotational force can be transferred from the tool to the driven member.

100. The combination tool and driven member of claim 98 wherein said handle comprises a knurled surface of said body.
